(19) United States
(12) Patent Application Publication
(10) Pub. No.: US 2010/0012334 A1
(43) Pub. Date: Jan. 21, 2010

(54) Inertization Method for Preventing Fires

(75) Inventor: Ernst-Werner Wagner, Winsen/Aller (DE)

Correspondence Address: AKERMAN SENTERFITT, 8100 BOONE BOULEVARD, SUITE 700, VIENNA, VA, 22182-2683, US

(73) Assignee: Amrona AG, Zug (CH)

(21) Appl. No.: 11/795,385

(22) PCT Filed: Jan. 13, 2006
(86) PCT No.: PCT/EP06/00267

§ 371 Date: Mar. 27, 2008

(30) Foreign Application Priority Data
Jan. 17, 2005 (DE) 10 2005 001 172.7

(51) Int. Cl. A62C 3/00

(52) U.S. Cl. 169/45

(57) ABSTRACT

An inertization method for preventing fire or explosion in an enclosed protected area in which the oxygen content in the protected area is lowered relative to the ambient air. With the objective of enabling effective protection against fire even given gas emissions from solids or liquids within the protected area, when inflammable substances and/or gases are present in the enclosed protected area (for example hydrocarbons), the method according to the invention provides for regulating the oxygen content in the closed protected area as a function of the concentration of said inflammable gases.

### CROSS-REFERENCE TO RELATED APPLICATIONS

The present invention is a 35 USC 371 national stage entry of international application No. PCT/EP2006/000267 filed Jan. 13, 2006, which claims priority from European Patent Application No. DE 10 2005 002 172.7, filed Jan. 17, 2005, the contents of which are herein incorporated by reference in their entirety.

### FIELD OF THE INVENTION

The present invention relates to an inertization method for preventing fire or explosion in an enclosed protected area by lowering the oxygen content in the protected area relative to the ambient air in the protected area.

### BACKGROUND

Inertization methods for preventing and extinguishing fires in closed spaces are known in firefighting technology. The resulting extinguishing effect of these methods is based on the principle of oxygen displacement. As is generally known, normal ambient air consists of 21% oxygen by volume, 78% nitrogen by volume and 1% by volume of other gases. To extinguish or prevent fires, an inert gas of pure or 90% nitrogen is introduced, for example, to further increase the nitrogen concentration in the protected area at issue and thus lower the oxygen percentage. An extinguishing effect is known to occur when the percentage of oxygen falls below about 15% by volume. Depending on the inflammable materials contained within the respective protected area, further lowering of the oxygen percentage to, e.g., 12% by volume may additionally be necessary. Most inflammable materials can no longer burn at this oxygen concentration.

The oxygen-displacing gases used in this “inert gas extinguishing method” are usually produced by a device, or are stored compressed in steel canisters in specific adjacent areas. Inert gas mixtures of, for example, 90%, 95% or 99% nitrogen (or another inert gas) are used in this method. The steel canisters or the device to produce the oxygen-displacing gas constitutes the so-called primary source of the inert gas fire-extinguishing system. In case of need, the gas is then channeled from this source through a pipeline system and the corresponding outlet nozzles into the respective protected area. In order to keep the fire risk as low as possible should the primary source fail, secondary sources of inert gas are occasionally employed as well.

Printed patent DE 102 35 718 B3 describes a method to inertize one or more closed spaces for reducing the risk of fire or explosion by lowering the oxygen content in the closed space to a nominal oxygen level compared to the ambient air. In this process, a gas temperature value in the closed space is also recorded and the nominal oxygen value for the oxygen content is determined contingent upon the temperature value, whereby the nominal oxygen value rises as the temperature value falls. This method has the disadvantage, however, that the nominal value can fluctuate greatly due to the physical characteristics, the geometry, the specific configuration or the covering of the materials stored in the protected space by other surface materials. One would thus have to determine an individual parameter for each physical characteristic and configuration of the goods stored in the protected space, which would be effectively impossible in practice. For this reason, a higher inert gas concentration is always selected for safety reasons so as to be able to ensure optimum protection against fire even given unfavorable physical conditions. One thereby automatically accepts a higher inert gas consumption, which incurs additional costs and can moreover impede people from entering the space.

Further, it is known that temperatures in the ranges of from −40° to +60° C. have no appreciable influence on the flammable limit of solid or liquid substances. On the other hand, gases can escape from modern materials—both solids, especially small goods containers and packaging material, as well as liquids. Despite a reduced oxygen content, such material emission of gases can represent an increased risk of fire or explosion. Hydrocarbons are an example of such an inflammable substance which increases the risk of fire and/or explosion.

Based on the problems described above in safely engineering an inert gas fire extinguishing system, and an inertization method respectively, an inertization method that functions reliably regardless of the type of materials and/or goods stored in the protected area, is needed.

### SUMMARY OF THE INVENTION

Exemplary embodiments consistent with the present invention relate to an inertization method wherein the nominal value for the oxygen concentration is regulated as a function of the concentration of inflammable gases in the protected space.

One advantage of the present invention is in the achievement of a simple to realize and thereby very effective inertization method for lowering the risk of fire or explosion in an enclosed protected area, even should there be increased concentrations of inflammable substances in the protected area due to gas emissions. In the process, the concentration of inflammable gases is determined by taking regular measurements. This overcomes the disadvantages of parameter-controlled inert gas and/or oxygen concentrations in the protected area. Further, variances in the variables of the stored materials are regulated by timely measurement and response to increased concentrations of inflammable gases from gas emissions.

The present invention also is directed to using one or a plurality of sensors to measure the concentration of inflammable gases in the protected space/area, at one location, at least. Multi-location measurements would be necessitated when, for example, objects or packaging material are randomly stored in a closed protected space. In such cases, or in the case of inauspicious geometrical conditions, the emissions of inflammable gases from the goods stored in the protected space can vary considerably.

The oxygen concentration in the protected space can likewise be measured at several locations and with one or a plurality of sensors. Taking measurements at several locations offers an additional safety aspect in terms of irregular dispersions of gas in closed protected spaces.

Moreover, the oxygen concentration can be measured with one or a plurality of sensors respectively. Technical reliability can be increased by taking measurements with at least two sensors.

The cited measured values for the concentration of inflammable gases in the protected space are moreover fed to at least one control unit just as the oxygen concentration in the protected space is fed. The control unit can evaluate the plurality of measured values supplied to it based on a selectable algorithm.

Further, one or more control units may be provided. The advantage of a multiple control unit configuration is the increased reliability of the system as a whole. It is thus ensured that even should one control unit fail, the system as a whole remains operational. If a rising concentration of inflammable gases is determined in the control unit from the sensors, the nominal oxygen concentration value is further lowered so as to ensure the reliable prevention of fire or explosion, even given the presence of inflammable gases (e.g. hydrocarbons).

Alternatively or additionally, one advantage is that the nominal value for the oxygen concentration may be increased as the concentration of inflammable gases decreases. This embodiment of the invention can, for example, allow people or other living creatures to enter the protected area without delay.

The oxygen concentration can be advantageously regulated by means of a characteristic curve stored in the control unit, for example: Fn=f(Kx).

Furthermore, the lowering of the concentration of inflammable gases which occur from the emission of gases from the goods stored in the storeroom can be reduced by providing a gas exchange, a fresh air supply respectively, in the protected space. This allows for reliably preventing a continuous rise in the concentration of inflammable gases from the gases being emitted and thus increasing the risk of fire or explosion.

Furthermore, the sensors in the protected space can transmit their signals wirelessly as need be. In this way, one can make allowances for the stored goods and/or goods geometries changing within the protected space.

The foregoing summary has outlined some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

The above and further advantages of the present invention my be better understood by referring to the following description taken in conjunction with the accompanying drawings, in which:

FIG. 1 shows a schematic representation of the protected area with its associated inert gas sources as well as the valve, measuring and control mechanisms of one embodiment consistent with the present invention; and

FIG. 2 shows an example of the change in oxygen concentration governed by the concentration of inflammable substances in the protected space, according to one embodiment consistent with the present invention.

### DETAILED DESCRIPTION OF EXEMPLARY EMBODIMENTS

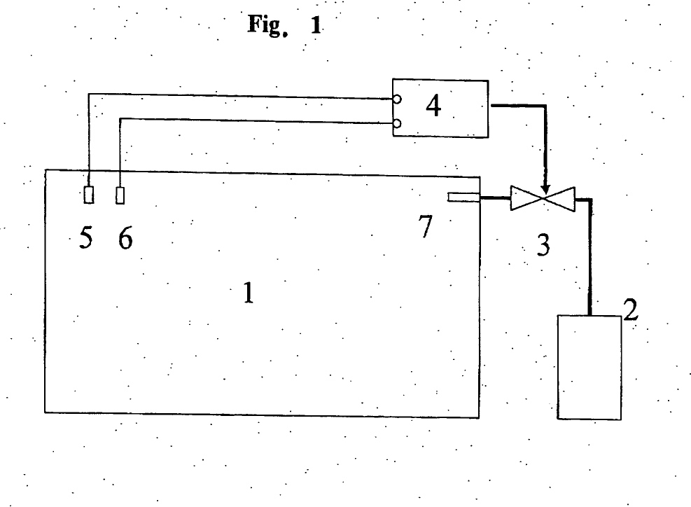

One embodiment of the present invention is represented in FIG. 1, which shows an example of the basic function including the associated control and measurement devices. The inert gas can be released from the inert gas source 2 through a valve 3 and one or more outlet nozzles 7 into protected area 1. The concentration of the inert gas in protected area 1 is thereby regulated by control unit 4, which in turn acts on valve 3. Control unit 4 is set such that a base inertization level is attained in protected area 1. This base inertization level reliably prevents fires in protected area 1 under normal conditions. Normal conditions refers to there not being increased concentrations of inflammable substances Kx in protected area 1. The control unit 4 thereto measures the oxygen concentration in protected area 1 with an oxygen sensor 5 and controls the inflow of inert gas accordingly. The presence and concentration of gases stemming from material gas emissions are determined with at least one further sensor 6. Should the concentration of inflammable or explosive gases in the ambient air of protected area 1 then increase (for example due to an increased concentration of hydrocarbons), this will be detected by sensor 6. This measured value is fed to the control unit 4. With the according characteristic map function in control unit 4 and valve 3, the inert gas concentration in protected area 1 is thereupon increased. The inflow of inert gas is continued until the desired lower oxygen concentration, measured by oxygen sensor 5, is reached in the protected area and a reliable fire protection is also given under these less favorable conditions.

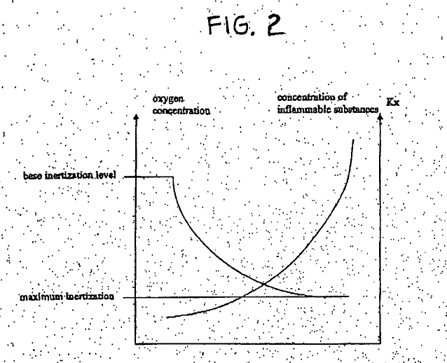

The representation of FIG. 2 shows an example of a possible gradient for the oxygen concentration in protected area 1 as a function of the concentration of inflammable gases Kx in the protected area 1. The oxygen concentration for the base inertization level thereby yields the level of inert gas necessary in order to minimize the risk of fire or explosion under normal conditions. The concentration of inert gas and the oxygen concentration dependent thereupon are controlled in accordance with a function Kn=f(Kx) which can be stored in the control unit. In this equation:

Kn=concentration of inert gas

Kx=concentration of inflammable gases.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

1.-8. (canceled)

9. An inertization method for preventing fire or explosion in an enclosed protected area, comprising:
lowering an oxygen content in the protected area to a base inertization level corresponding to a reduced oxygen content relative to ambient air;
wherein the reduced oxygen content in the protected area corresponding to the base inertization level is set subject to a concentration of inflammable gases in the protected area.

10. The method according to claim 1, further comprising:
measuring the concentration of inflammable gases in the protected area at one or a plurality of locations with one or more sensors respectively.

11. The method according to claim 1, further comprising:
measuring the oxygen content in the protected area at one or a plurality of locations with one or more sensors respectively.

12. The method according to claim 11, further comprising:
feeding the measured values for the concentration of inflammable gases and/or oxygen content to at least one control unit.

13. The method according to claim 12, further comprising:
lowering a nominal value for the oxygen content with an increasing concentration of inflammable gases.

14. The method according to claim 12, further comprising:
increasing a nominal value for the oxygen content with an decreasing concentration of inflammable gases.

15. The method according to claim 12, wherein the control unit regulates the nominal value for the oxygen content in accordance with a characteristic curve stored in said control unit.

16. The method according to claim 1, further comprising:
reducing the concentration of inflammable gases by gas exchange and/or by supplying fresh air into the protected area.
